(19) United States
(12) Patent Application Publication
(10) Pub. No.: US 2023/0361426 A1
(43) Pub. Date: Nov. 9, 2023

(54) BATTERY AND METHOD FOR MANUFACTURING THE SAME

(71) Applicant: Panasonic Intellectual Property Management Co., Ltd., Osaka (JP)

(72) Inventors: KUNIHIKO MINEYA, OSAKA (JP); TADAAKI MATSUMURA, SHIGA (JP)

(21) Appl. No.: 18/355,436

(22) Filed: Jul. 20, 2023

Related U.S. Application Data
(63) Continuation of application No. PCT/JP2021/043140, filed on Nov. 25, 2021.

(30) Foreign Application Priority Data
Feb. 8, 2021 (JP) 2021-018463

(51) Int. Cl. H01M 50/44; H01M 10/0525; H01M 50/417; H01M 4/38; H01M 50/449

(52) U.S. Cl. CPC H01M 50/44; H01M 10/0525; H01M 50/417; H01M 4/386; H01M 50/449; H01M 2004/027

(57) ABSTRACT

A battery includes a first electrode, a second electrode, and a solid electrolyte layer located between the first electrode and the second electrode and including a fibrous material, wherein the solid electrolyte layer includes a first solid electrolyte layer, and a second solid electrolyte layer located between the first solid electrolyte layer and the second electrode, and the content ratio of the fibrous material in the second solid electrolyte layer is higher than the content ratio of the fibrous material in the first solid electrolyte layer.

### BACKGROUND

### 1. Technical Field

The present disclosure relates to a battery and a method for manufacturing the same.

### 2. Description of the Related Art

Carbon materials are main negative electrode active materials used in negative electrodes of batteries. A higher battery capacity is explored through the use of an alloying material, for example silicon, as a negative electrode active material.

Japanese Unexamined Patent Application Publication No. 2011-60558 discloses a nonaqueous electrolyte battery that includes a negative electrode active material layer containing an alloying material as a negative electrode active material, and a fibrous inorganic material.

### SUMMARY

In the conventional art, there is a demand that discharge rate characteristics and charge-discharge efficiency be satisfied at the same time.

In one general aspect, the techniques disclosed here feature a battery including a first electrode, a second electrode, and a solid electrolyte layer located between the first electrode and the second electrode and including a fibrous material, wherein the solid electrolyte layer includes a first solid electrolyte layer, and a second solid electrolyte layer located between the first solid electrolyte layer and the second electrode, and the content ratio of the fibrous material in the second solid electrolyte layer is higher than the content ratio of the fibrous material in the first solid electrolyte layer.

The battery provided according to the present disclosure suitably satisfies discharge rate characteristics and charge-discharge efficiency at the same time.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view illustrating a schematic configuration of a battery according to an embodiment;

FIG. 2 is a sectional view illustrating a detailed configuration of a solid electrolyte layer and a negative electrode;

FIG. 3 is a sectional view illustrating a configuration of a solid electrolyte layer and a negative electrode in Modification Example 1;

FIG. 4 is a sectional view illustrating a configuration of a solid electrolyte layer and a negative electrode in Comparative Example 1;

FIG. 5 is a sectional view illustrating a configuration of a solid electrolyte layer and a negative electrode in Comparative Example 2; and

FIG. 6 is a sectional view illustrating a configuration of a solid electrolyte layer and a negative electrode in Comparative Example 3.

### DETAILED DESCRIPTIONS

### Underlying Knowledge Forming Basis of the Present Disclosure

When a negative electrode includes an alloying active material, the intercalation reaction and the deintercalation reaction of lithium ions expand and contract the alloying active material to cause a significant change in the volume of the negative electrode. The volume change of the negative electrode due to the expansion of the alloying active material may give rise to a crack in a solid electrolyte layer that is an insulating layer. In this event, the solid electrolyte layer lowers its insulating function. The lowering in the insulating function results in local conduction between the positive and negative electrodes to allow an electric current (e⁻) to flow directly between the positive and negative electrodes (so-called a leakage current). Thus, a certain amount of electricity applied during charging is not used for the intercalation of lithium ions into the negative electrode active material (Li⁺e⁻→Li), and an extra amount of e⁻ is charged over the amount of Li that can be discharged. This means a decrease in charge-discharge efficiency of the battery.

A solid-state battery, in particular, has dense structures in a solid electrolyte layer and in a negative electrode active material layer, with little space for accepting the expansion of the negative electrode active material. Solid-state batteries are subjected to stricter constraints in terms of the expansion of a negative electrode active material than liquid electrolyte batteries.

A possible approach to solving the above problem is to increase the thickness of a solid electrolyte layer that is an insulating layer. However, increasing the thickness of a solid electrolyte layer increases the value of resistance of the solid electrolyte layer, and thus deteriorates discharge rate characteristics of the battery. Furthermore, increasing the thickness of a solid electrolyte layer, which does not contribute to the energy density of the battery, lowers the energy density of the battery.

As described above, difficulties are encountered in satisfying at the same time discharge rate characteristics and charge-discharge efficiency of batteries using alloying active materials. Thus, concurrent satisfaction of discharge rate characteristics and charge-discharge efficiency is desired.

### Outlines of Aspects According to the Present Disclosure

A battery according to the first aspect of the present disclosure includes:

a first electrode;

a second electrode; and

a solid electrolyte layer located between the first electrode and the second electrode and including a fibrous material,

wherein

the solid electrolyte layer includes a first solid electrolyte layer, and a second solid electrolyte layer located between the first solid electrolyte layer and the second electrode, and

the content ratio of the fibrous material in the second solid electrolyte layer is higher than the content ratio of the fibrous material in the first solid electrolyte layer.

According to the above configuration, the fibrous material increases the strength of the solid electrolyte layer. As a result, the solid electrolyte layer is resistant to cracking even when, for example, an alloying active material is expanded during the lithium-ion intercalation reaction. Furthermore, the solid electrolyte layer is prevented from cracking without the need of increasing the thickness of the solid electrolyte layer, and it is therefore possible to avoid a decrease in discharge rate characteristics. Thus, the battery that is provided can suitably satisfy discharge rate characteristics and charge-discharge efficiency at the same time.

In the second aspect of the present disclosure, for example, the battery according to the first aspect may be such that the first solid electrolyte layer does not include the fibrous material. The battery having such a configuration can sufficiently ensure discharge rate characteristics and charge-discharge efficiency.

In the third aspect of the present disclosure, for example, the battery according to the first aspect or the second aspect may be such that the first electrode is a positive electrode, and the second electrode is a negative electrode. When, for example, the negative electrode includes an alloying active material, the above configuration allows the battery to achieve a smaller decrease in charge-discharge efficiency due to volume expansion of the alloying active material.

In the fourth aspect of the present disclosure, for example, the battery according to the third aspect may be such that the negative electrode includes a negative electrode active material, and the negative electrode active material includes at least one selected from the group consisting of silicon, tin, and titanium. These materials used as the negative electrode active materials can offer a higher energy density of the battery.

In the fifth aspect of the present disclosure, for example, the battery according to any one of the first aspect to the fourth aspect may be such that the negative electrode active material includes silicon. Silicon used as the negative electrode active material can offer a higher energy density of the battery.

In the sixth aspect of the present disclosure, for example, the battery according to any one of the first aspect to the fifth aspect may be such that the fibrous material includes a polyolefin. A polyolefin is a substance that is electrochemically stable at potentials of the positive electrode and the negative electrode, and is therefore suitable as the fibrous material.

In the seventh aspect of the present disclosure, for example, the battery according to the sixth aspect may be such that the fibrous material includes polypropylene. Polypropylene is a substance that is electrochemically stable at potentials of the positive electrode and the negative electrode, and is therefore suitable as the fibrous material.

In the eighth aspect of the present disclosure, for example, the battery according to any one of the first aspect to the seventh aspect may be such that the content ratio of the fibrous material in the second solid electrolyte layer is greater than or equal to 0.05 mass % and less than or equal to 5 mass %. The advantageous effects described above may be sufficiently obtained by controlling the content of the fibrous material appropriately.

In the ninth aspect of the present disclosure, for example, the battery according to the eighth aspect may be such that the content ratio of the fibrous material in the second solid electrolyte layer is greater than or equal to 0.1 mass % and less than or equal to 1 mass %. The advantageous effects described above may be sufficiently obtained by controlling the content of the fibrous material appropriately.

In the tenth aspect of the present disclosure, for example, the battery according to the ninth aspect may be such that the content ratio of the fibrous material in the second solid electrolyte layer is greater than or equal to 0.1 mass % and less than or equal to 0.2 mass %. The advantageous effects described above may be sufficiently obtained by controlling the content of the fibrous material appropriately.

In the eleventh aspect of the present disclosure, for example, the battery according to any one of the first aspect to the tenth aspect may be such that the thickness of the second solid electrolyte layer is smaller than the thickness of the first solid electrolyte layer. The battery having this configuration is excellent in the balance between discharge rate characteristics and energy density.

In the twelfth aspect of the present disclosure, for example, the battery according to any one of the first aspect to the eleventh aspect may be such that the first solid electrolyte layer further includes a first solid electrolyte, the second solid electrolyte layer further includes a second solid electrolyte, and the first solid electrolyte and the second solid electrolyte have lithium-ion conductivity. The solid electrolyte layer having this configuration can attain high lithium-ion conductivity.

A battery manufacturing method according to the thirteenth aspect of the present disclosure includes laminating:

a first electrode;

a second electrode;

a first solid electrolyte layer between the first electrode and the second electrode; and

a second solid electrolyte layer between the first solid electrolyte layer and the second electrode,

wherein

the content ratio of a fibrous material in the second solid electrolyte layer is higher than the content ratio of a fibrous material in the first solid electrolyte layer.

According to the above configuration, the fibrous material increases the strength of the solid electrolyte layers. As a result, the solid electrolyte layers are resistant to cracking even when, for example, an alloying active material is expanded during the lithium-ion intercalation reaction. Furthermore, the solid electrolyte layers are prevented from cracking without the need of increasing the thickness of the solid electrolyte layers, and it is therefore possible to avoid a decrease in discharge rate characteristics. Thus, a battery can be manufactured that suitably satisfies discharge rate characteristics and charge-discharge efficiency at the same time.

In the fourteenth aspect of the present disclosure, for example, the battery manufacturing method according to the thirteenth aspect may produce a battery in which the first solid electrolyte layer does not include the fibrous material. The battery having such a configuration can sufficiently ensure discharge rate characteristics and charge-discharge efficiency.

In the fifteenth aspect of the present disclosure, for example, the battery manufacturing method according to the thirteenth aspect or the fourteenth aspect may produce a battery in which the first electrode is a positive electrode, and the second electrode is a negative electrode. When, for example, the negative electrode includes an alloying active material, the above configuration allows the battery to achieve a smaller decrease in charge-discharge efficiency due to volume expansion of the alloying active material.

Hereinbelow, embodiments of the present disclosure will be described with reference to the drawings. The present disclosure is not limited to the following embodiments.

### EMBODIMENTS

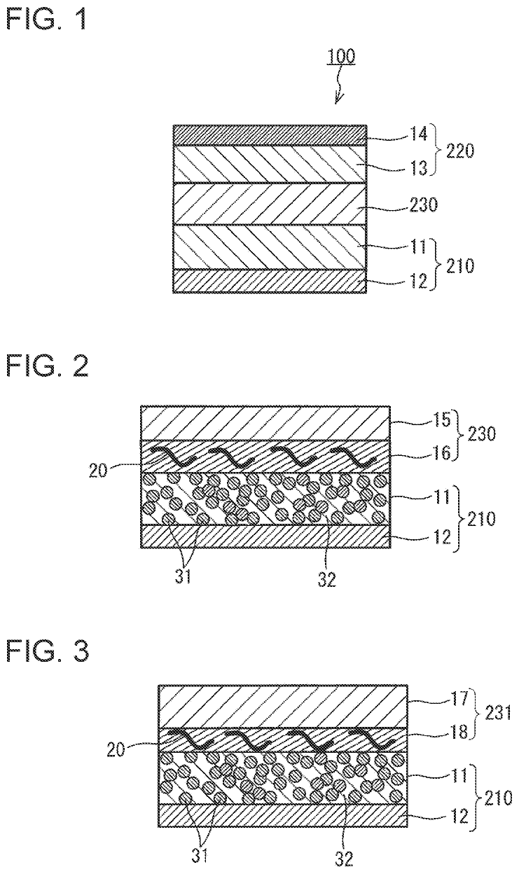

FIG. 1 is a sectional view illustrating a schematic configuration of a battery 100 according to an embodiment. The battery 100 includes a positive electrode 220, a negative electrode 210, and a solid electrolyte layer 230. The positive electrode 220 is an example of a first electrode. The negative electrode 210 is an example of a second electrode.

The positive electrode 220 has a positive electrode active material layer 13 and a positive electrode current collector 14. The positive electrode active material layer 13 is disposed between the solid electrolyte layer 230 and the positive electrode current collector 14. The positive electrode active material layer 13 is in electrical contact with the positive electrode current collector 14.

In the present embodiment, the positive electrode active material layer 13 is in contact with the positive electrode current collector 14. Alternatively, the positive electrode active material layer 13 may be separate from the positive electrode current collector 14. An additional layer may be provided between the positive electrode active material layer 13 and the positive electrode current collector 14. The positive electrode active material layer 13 is in contact with the solid electrolyte layer 230.

The positive electrode current collector 14 is a member that functions to collect power from the positive electrode active material layer 13. Exemplary materials for the positive electrode current collectors 14 include aluminum, aluminum alloys, stainless steel, copper, and nickel. The positive electrode current collector 14 may be made of aluminum or an aluminum alloy. Configurations, such as dimension and shape, of the positive electrode current collector 14 may be selected appropriately in accordance with the use application of the battery 100.

The positive electrode active material layer 13 includes a positive electrode active material and a solid electrolyte. The positive electrode active material that is used may be a material capable of adsorbing and releasing metal ions, such as lithium ions. For example, a lithium-containing transition metal oxide, a transition metal fluoride, a polyanion material, a fluorinated polyanion material, a transition metal sulfide, a transition metal oxysulfide, or a transition metal oxynitride may be used as the positive electrode active material. In particular, the use of a lithium-containing transition metal oxide as the positive electrode active material saves the manufacturing costs and offers a high average discharge voltage.

The positive electrode active material may include Li and at least one element selected from the group consisting of Mn, Co, Ni, and Al. Examples of such materials include Li(NiCoAl)O₂, Li(NiCoMn)O₂, and LiCoO₂.

The positive electrode active material may include elemental sulfur (S₈) or a sulfur-containing material, such as lithium sulfur (Li₂S). The positive electrode active material layer 13 may exclusively include elemental sulfur (S₈) as the positive electrode active material. The positive electrode active material layer 13 may exclusively include lithium sulfur (Li₂S) as the positive electrode active material.

For example, the positive electrode active material has a particulate shape. The shape of the particles of the positive electrode active material is not particularly limited. The shape of the particles of the positive electrode active material may be acicular, spherical, oval, or scaly.

The median diameter of the particles of the positive electrode active material may be greater than or equal to 0.1 μm and less than or equal to 100 μm. When the median diameter of the particles of the positive electrode active material is greater than or equal to 0.1 μm, the positive electrode active material and the solid electrolyte may be favorably dispersed in the positive electrode 220, with the result that charge/discharge characteristics of the battery 100 are enhanced. When the median diameter of the particles of the positive electrode active material is less than or equal to 100 μm, lithium can be diffused quickly in the particles of the positive electrode active material. Thus, the battery 100 may be operated at a high output.

In the present disclosure, the “median diameter” means the particle size at 50% cumulative volume in the volume-based grain size distribution. For example, the volume-based grain size distribution may be measured with a laser diffraction measurement device or an image analyzer.

The solid electrolyte used in the positive electrode 220 may be at least one selected from the group consisting of sulfide solid electrolytes, oxide solid electrolytes, halide solid electrolytes, polymer solid electrolytes, and complex hydride solid electrolytes. Oxide solid electrolytes have excellent stability at high potentials. The charge-discharge efficiency of the battery 100 may be further enhanced by using an oxide solid electrolyte.

Examples of the sulfide solid electrolytes that may be used include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂Si₂. For example, LiX, Li₂O, MO_{q}, and LiₚMO_{q} may be added to those described above. Here, the element X in “LiX” is at least one element selected from the group consisting of F, Cl, Br, and I. The element M in “MO_{q}” and “LiₚMO_{q}” is at least one element selected from the group consisting of P, Si, Ge, B, Al, Ga, In, Fe, and Zn. The letters p and q in “MO_{q}” and “LiₚMO_{q}” are each independently a natural number.

Examples of the oxide solid electrolytes that may be used include NASICON-type solid electrolytes represented by LiTi₂(PO₄)₃ and element-substituted derivatives thereof; Perovskite-type solid electrolytes, such as (LaLi)TiO₃ system; LISICON-type solid electrolytes represented by Li₁₄ZnGe₄O₁₆, Li₄SiO₄, LiGeO₄, and element-substituted derivatives thereof; garnet-type solid electrolytes represented by Li₇La₃Zr₂O₁₂ and element-substituted derivatives thereof; Li₃N and H-substituted derivatives thereof; Li₃PO₄ and N-substituted derivatives thereof; and glass or glass ceramic electrolytes that are based on a material including a Li—B—O compound, such as LiBO₂ or Li₃BO₃, and contain such a material as Li₂SO₄ or Li₂CO₃.

Examples of the polymer solid electrolytes that may be used include compounds formed between a polymer compound and a lithium salt. The polymer compound may have an ethylene oxide structure. By having an ethylene oxide structure, the polymer compound can contain a large amount of the lithium salt and thus can offer higher ion conductivity. Examples of the lithium salts that may be used include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. The lithium salt that is used may be a single kind of lithium salt selected from those described above, or may be a mixture of two or more kinds of lithium salts selected from those described above.

Examples of the complex hydride solid electrolytes that may be used include LiBH₄—LiI and LiBH₄—P₂S₅.

For example, the halide solid electrolyte is represented by the following compositional formula (1). In the compositional formula (1), α, β, and γ are each independently a value greater than 0. M includes at least one element selected from the group consisting of metal elements other than Li, and metalloid elements. X includes at least one selected from the group consisting of F, Cl, Br, and I.

Li_{α}M_{β}X_{γ} (1)

The metalloid elements include B, Si, Ge, As, Sb, and Te. The metal elements include all the elements in Group 1 to Group 12 of the periodic table except hydrogen, and all the elements in Group 13 to Group 16 except B, Si, Ge, As, Sb, Te, C, N, P, O, S, and Se. The metal elements are a group of elements that can form cations when they form inorganic compounds with halogen compounds.

Examples of the halide solid electrolytes that may be used include Li₃YX₆, Li₂MgX₄, Li₂FeX₄, Li(Al, Ga, In)X₄, and Li₃(Al, Ga, In)X₆.

In the present disclosure, the expression of elements, for example, “(Al, Ga, In)” in a formula indicates at least one element selected from the elements in parentheses. That is, “(Al, Ga, In)” is synonymous with “at least one selected from the group consisting of Al, Ga, and In”. The same applies to other elements. The halide solid electrolytes exhibit excellent ion conductivity.

For example, the solid electrolyte contained in the positive electrode 220 has a particulate shape. The shape of the particles of the solid electrolyte is not particularly limited. The shape of the particles of the solid electrolyte may be acicular, spherical, oval, or scaly.

When the solid electrolyte contained in the positive electrode 220 has a particulate (for example, spherical) shape, the median diameter of the particles of the solid electrolyte may be less than or equal to 100 μm. When the median diameter is less than or equal to 100 μm, the positive electrode active material and the solid electrolyte may be favorably dispersed in the positive electrode 220, with the result that charge/discharge characteristics of the battery 100 are enhanced.

In the positive electrode 220, the volume ratio “v1:100-v1” of the positive electrode active material to the solid electrolyte may satisfy 30≤v1≤95. Here, v1 indicates the volume proportion of the positive electrode active material relative to the total volume of the positive electrode active material and the solid electrolyte present in the positive electrode 220 taken as 100. When 30≤v1 is satisfied, a sufficient energy density of the battery 100 is ensured. When v1≤95 is satisfied, the battery 100 may be operated at a high output.

The thickness of the positive electrode 220 may be greater than or equal to 10 μm and less than or equal to 500 μm. When the thickness of the positive electrode 220 is greater than or equal to 10 μm, a sufficient energy density of the battery 100 is ensured. When the thickness of the positive electrode 220 is less than or equal to 500 μm, the battery 100 may be operated at a high output.

The positive electrode active material layer 13 may be formed by a wet process, a dry process, or a combination of a wet process and a dry process. In the wet process, a slurry containing the raw materials is applied onto the positive electrode current collector 14. In the dry process, powders of the raw materials are compacted together with the positive electrode current collector 14.

The solid electrolyte layer 230 is located between the positive electrode 220 and the negative electrode 210. The solid electrolyte layer 230 is a layer including a solid electrolyte.

FIG. 2 is a sectional view illustrating a detailed configuration of the solid electrolyte layer 230 and the negative electrode 210 in the battery 100. The solid electrolyte layer 230 has a first solid electrolyte layer 15 and a second solid electrolyte layer 16. The second solid electrolyte layer 16 is located between the first solid electrolyte layer 15 and the negative electrode 210.

In the present embodiment, the first solid electrolyte layer 15 is in contact with the second solid electrolyte layer 16. The first solid electrolyte layer 15 is in contact with the positive electrode active material layer 13. The second solid electrolyte layer 16 is in contact with the negative electrode active material layer 11.

The first solid electrolyte layer 15 includes a first solid electrolyte. The second solid electrolyte layer 16 includes a second solid electrolyte.

The solid electrolyte layer 230 includes a fibrous material 20. The content ratio of the fibrous material 20 in the second solid electrolyte layer 16 is higher than the content ratio of the fibrous material 20 in the first solid electrolyte layer 15. In the battery 100 having this configuration, the fibrous material 20 increases the strength of the solid electrolyte layer 230. As a result, the solid electrolyte layer 230 is resistant to cracking even when a negative electrode active material 31 contained in the negative electrode active material layer 11 is expanded during the lithium-ion intercalation reaction. Furthermore, the solid electrolyte layer 230 is prevented from cracking without the need of increasing the thickness of the solid electrolyte layer 230, and it is therefore possible to avoid a decrease in discharge rate characteristics. In this manner, the battery 100 can satisfy discharge rate characteristics and charge-discharge efficiency at the same time. In the present disclosure, the “content ratio of the fibrous material in the second solid electrolyte layer” means the ratio ((M/M2)×100 mass %) of the mass M of the fibrous material 20 to the mass M2 of the second solid electrolyte contained in the second solid electrolyte layer 16. Similarly, the “content ratio of the fibrous material in the first solid electrolyte layer” means the ratio ((M/M1)×100 mass %) of the mass M of the fibrous material 20 to the mass M1 of the first solid electrolyte contained in the first solid electrolyte layer 15.

The ratio R of the content ratio of the fibrous material 20 in the first solid electrolyte layer 15 to the content ratio of the fibrous material 20 in the second solid electrolyte layer 16 (the content ratio of the fibrous material 20 in the first solid electrolyte layer 15/the content ratio of the fibrous material 20 in the second solid electrolyte layer 16) may be less than or equal to 0.9, or may be less than or equal to 0.5. When the ratio R is in the above range, the increase in the value of resistance of the solid electrolyte layer 230 is reduced.

In the present disclosure, the “fibrous material” means a substance having, for example, an aspect ratio of greater than or equal to 3. The aspect ratio of the fibrous material 20 is defined as the ratio of the average length to the average diameter of the fibrous material 20. The aspect ratio of the fibrous material 20 may be greater than or equal to 5 and less than or equal to 1000. The fibrous material 20 with this configuration has excellent strength.

The average diameter of the fibrous material 20 may be greater than or equal to 10 nm and less than or equal to 20 μm. The average diameter of the fibrous material 20 is calculated as the average of the minimum diameters of at least twenty fibers of the fibrous material 20 measured with respect to an electron microscope image.

The average length of the fibrous material 20 may be greater than or equal to 50 nm and less than or equal to 20 mm. The average length of the fibrous material 20 is calculated as the average of the maximum lengths of at least twenty fibers of the fibrous material 20 measured with respect to an electron microscope image.

The fibrous material 20 is a substance that is electrochemically stable at potentials of the positive electrode 220 and the negative electrode 210. In the present disclosure, the phrase that a substance is electrochemically stable at potentials of the positive electrode and the negative electrode means that the substance does not undergo redox reaction at a range of potentials of the positive electrode and the negative electrode.

The fibrous material 20 that is used may be an insulating material. The insulating material may be an organic material or an inorganic material. Examples of the organic materials include resin materials, such as acrylic resins, fluororesins, epoxy resins, polyethylene resins, polypropylene resins, and vinyl chloride resins. Examples of the inorganic materials include boehmites. The boehmites include pseudoboehmites. Pseudoboehmites are materials that include a hydrated alumina differing partially in crystal structure from boehmite. One, or a combination of two or more selected from those materials described above may be used as the fibrous material 20. The fibrous material 20 that is used may be an insulating material alone. In the present disclosure, the “insulating material” means a material having a value of resistance higher than the value of resistance of the solid electrolyte contained in the solid electrolyte layer 230.

The fibrous material 20 may include a polyolefin. A polyolefin is a substance that is electrochemically stable at potentials of the positive electrode 220 and the negative electrode 210, and is therefore suitable as the fibrous material 20. Examples of the polyolefins include polyethylene, polypropylene, and propylene-ethylene copolymer. The fibrous material 20 may consist of polypropylene.

The first solid electrolyte layer 15 may be free from the fibrous material 20. That is, the content ratio of the fibrous material 20 in the first solid electrolyte layer 15 may be zero. In the solid electrolyte layer 230, the second solid electrolyte layer 16 alone may include the fibrous material 20. The battery 100 having this configuration can satisfy discharge rate characteristics and charge-discharge efficiency at the same time. In the present disclosure, the phrase that “the first solid electrolyte layer is free from the fibrous material” or “the first solid electrolyte layer does not include the fibrous material” means that the fibrous material 20 is not intentionally added as a material for the first solid electrolyte layer 15. For example, the fibrous material 20 is regarded as being not intentionally added to the first solid electrolyte layer 15 when the content ratio of the fibrous material 20 in the first solid electrolyte layer 15 is less than or equal to 0.01 mass %.

The content ratio of the fibrous material 20 in the second solid electrolyte layer 16 may be greater than or equal to 0.05 mass % and less than or equal to 5 mass %. When the content ratio of the fibrous material 20 is greater than or equal to 0.05 mass %, the advantageous effects described hereinabove are obtained sufficiently. When the content ratio of the fibrous material 20 is less than or equal to 5 mass %, the increase in the value of resistance of the solid electrolyte layer 230 can be reduced. As a result, the battery 100 suffers a smaller decrease in discharge rate characteristics.

The content ratio of the fibrous material 20 in the second solid electrolyte layer 16 may be greater than or equal to 0.1 mass % and less than or equal to 1 mass %. This configuration can further reduce the increase in the value of resistance of the solid electrolyte layer 230.

The content ratio of the fibrous material 20 in the second solid electrolyte layer 16 may be greater than or equal to 0.1 mass % and less than or equal to 0.2 mass %. This configuration can still further reduce the increase in the value of resistance of the solid electrolyte layer 230.

The solid electrolyte layer 230 may include at least one solid electrolyte selected from the group consisting of halide solid electrolytes, sulfide solid electrolytes, oxide solid electrolytes, polymer solid electrolytes, and complex hydride solid electrolytes. The sulfide solid electrolytes, the oxide solid electrolytes, the halide solid electrolytes, the polymer solid electrolytes, and the complex hydride solid electrolytes may be those described with respect to the positive electrode 220.

For example, the solid electrolyte contained in the solid electrolyte layer 230 has a particulate shape. The shape of the particles is not particularly limited, and is, for example, acicular, spherical, or oval.

In the present disclosure, “the solid electrolyte contained in the solid electrolyte layer” means that the solid electrolyte includes the first solid electrolyte and the second solid electrolyte.

In the solid electrolyte layer 230, the composition of the material of the first solid electrolyte layer 15 may be different from the composition of the material of the second solid electrolyte layer 16. That is, the composition of the first solid electrolyte may differ from the composition of the second solid electrolyte. The first solid electrolyte, which is contained in the first solid electrolyte layer 15 in contact with the positive electrode 220, may be a halide solid electrolyte having excellent oxidation resistance. The second solid electrolyte, which is contained in the second solid electrolyte layer 16 in contact with the negative electrode 210, may be a sulfide solid electrolyte having excellent reduction resistance. The composition of the first solid electrolyte may be the same as the composition of the second solid electrolyte.

The solid electrolyte contained in the solid electrolyte layer 230 has lithium-ion conductivity. That is, the first solid electrolyte and the second solid electrolyte have lithium-ion conductivity. This configuration provides high lithium-ion conductivity in the solid electrolyte layer 230.

The thickness of the solid electrolyte layer 230 may be greater than or equal to 1 μm and less than or equal to 300 μm. When the thickness of the solid electrolyte layer 230 is greater than or equal to 1 μm, a short circuit between the positive electrode 220 and the negative electrode 210 can be reliably prevented. When the thickness of the solid electrolyte layer 230 is less than or equal to 300 μm, the battery 100 may be operated at a high output.

In the solid electrolyte layer 230, the thickness of the second solid electrolyte layer 16 may be equal to the thickness of the first solid electrolyte layer 15.

FIG. 3 is a sectional view illustrating a configuration of a solid electrolyte layer 231 and the negative electrode 210 in Modification Example 1. In the solid electrolyte layer 231, the thickness of a second solid electrolyte layer 18 is smaller than the thickness of a first solid electrolyte layer 17. The battery having this configuration is excellent in the balance between discharge rate characteristics and energy density. For example, the ratio T2/T1 is in the range of 1/2 to 1/20 wherein T2 is the thickness of the second solid electrolyte layer 18, and T1 is the thickness of the first solid electrolyte layer 17.

The thickness of each layer may be the average at randomly chosen points in a cross section of the battery 100 viewed from above including the center of gravity.

The negative electrode 210 includes a negative electrode active material layer 11 and a negative electrode current collector 12. The negative electrode active material layer 11 is disposed between the solid electrolyte layer 230 and the negative electrode current collector 12. The negative electrode active material layer 11 is in electrical contact with the negative electrode current collector 12.

In the present embodiment, the negative electrode active material layer 11 is in contact with the negative electrode current collector 12. Alternatively, the negative electrode active material layer 11 may be separate from the negative electrode current collector 12. An additional layer may be provided between the negative electrode active material layer 11 and the negative electrode current collector 12. The negative electrode active material layer 11 is in contact with the solid electrolyte layer 230.

The negative electrode current collector 12 is a member that functions to collect power from the negative electrode active material layer 11. Exemplary materials for the negative electrode current collectors 12 include aluminum, aluminum alloys, stainless steel, copper, and nickel. The negative electrode current collector 12 may be made of nickel. Configurations, such as dimension and shape, of the negative electrode current collector 12 may be selected appropriately in accordance with the use application of the battery 100.

As illustrated in FIG. 2, the negative electrode active material layer 11 includes a negative electrode active material 31 and a solid electrolyte 32. The negative electrode active material 31 that is used may be a material capable of adsorbing and releasing metal ions, such as lithium ions. When the negative electrode active material layer 11 includes, as the negative electrode active material 31, a material capable of adsorbing and releasing metal ions, the battery 100 attains an increased energy density.

The material capable of adsorbing and releasing metal ions may be a carbon material. Examples of the carbon materials include natural graphite, cokes, semi-graphitized carbon, carbon fibers, spherical carbon, artificial graphite, and amorphous carbon. A single carbon material, or a mixture of two or more carbon materials may be used.

Alternatively, the material capable of adsorbing and releasing metal ions may be, for example, a metal material, an oxide, a nitride, a tin compound, or a silicon compound. The metal material is typically a metal or a metalloid. The metal or the metalloid may be an element. The metal material is not necessarily an elemental metal or metalloid. The metal material may be a compound that includes an element alloyable with lithium. Examples of the metal materials include lithium metal and lithium alloys. These materials may be used singly, or two or more may be used as a mixture.

The negative electrode active material 31 may include at least one selected from the group consisting of silicon, tin, and titanium. These materials are alloyable with lithium, and have a higher theoretical capacity than carbon materials. Thus, the use of these materials as the negative electrode active material 31 can increase the energy density of the battery 100.

The negative electrode active material 31 may include silicon. Silicon is not limited to elemental silicon. That is, the negative electrode active material 31 may include at least one selected from the group consisting of elemental silicon and silicon oxides represented by SiOₓ (0<x<2).

For example, the negative electrode active material 31 has a particulate shape. The shape of the particles of the negative electrode active material 31 is not particularly limited. The shape of the particles of the negative electrode active material 31 may be acicular, spherical, oval, or scaly.

The median diameter of the particles of the negative electrode active material 31 may be greater than or equal to 0.1 μm and less than or equal to 100 μm. When the median diameter of the particles of the negative electrode active material 31 is greater than or equal to 0.1 μm, the negative electrode active material 31 and the solid electrolyte 32 may be favorably dispersed in the negative electrode 210, with the result that charge/discharge characteristics of the battery 100 are enhanced. When the median diameter of the particles of the negative electrode active material 31 is less than or equal to 100 μm, lithium can be diffused quickly in the particles of the negative electrode active material 31. Thus, the battery 100 may be operated at a high output.

The solid electrolyte 32 that is used may be at least one selected from the group consisting of sulfide solid electrolytes, oxide solid electrolytes, halide solid electrolytes, polymer solid electrolytes, and complex hydride solid electrolytes. The sulfide solid electrolytes, the oxide solid electrolytes, the halide solid electrolytes, the polymer solid electrolytes, and the complex hydride solid electrolytes may be those described with respect to the positive electrode 220.

For example, the solid electrolyte 32 has a particulate shape. The shape of the particles of the solid electrolyte 32 is not particularly limited. The shape of the particles of the solid electrolyte 32 may be acicular, spherical, oval, or scaly.

When the solid electrolyte 32 has a particulate (for example, spherical) shape, the median diameter of the particles of the solid electrolyte 32 may be less than or equal to 100 μm. When the median diameter is less than or equal to 100 μm, the negative electrode active material 31 and the solid electrolyte 32 may be favorably dispersed in the negative electrode 210, with the result that charge/discharge characteristics of the battery 100 are enhanced.

When the solid electrolyte 32 has a particulate (for example, spherical) shape, the median diameter of the particles of the solid electrolyte 32 may be smaller than the median diameter of the particles of the negative electrode active material 31. This configuration allows the negative electrode active material 31 and the solid electrolyte 32 to be dispersed more favorably in the negative electrode 210.

In the negative electrode 210, the volume ratio “v2:100-v2” of the negative electrode active material 31 to the solid electrolyte 32 may satisfy 30≤v2≤95. Here, v2 indicates the volume proportion of the negative electrode active material 31 relative to the total volume of the negative electrode active material 31 and the solid electrolyte 32 present in the negative electrode 210 taken as 100. When 30≤v2 is satisfied, a sufficient energy density of the battery 100 is ensured. When v2≤95 is satisfied, the battery 100 may be operated at a high output.

The thickness of the negative electrode 210 may be greater than or equal to 10 μm and less than or equal to 500 μm. When the thickness of the negative electrode 210 is greater than or equal to 10 μm, a sufficient energy density of the battery 100 is ensured. When the thickness of the negative electrode 210 is less than or equal to 500 μm, the battery 100 may be operated at a high output.

The negative electrode active material layer 11 may be formed by a wet process, a dry process, or a combination of a wet process and a dry process. In the wet process, a slurry containing the raw materials is applied onto the negative electrode current collector 12. In the dry process, powders of the raw materials are compacted together with the negative electrode current collector 12.

To facilitate the transfer of lithium ions and enhance the output characteristics of the battery, at least one of the positive electrode active material layer 13, the solid electrolyte layer 230, or the negative electrode active material layer 11 may include at least one selected from the group consisting of sulfide solid electrolytes, oxide solid electrolytes, halide solid electrolytes, polymer solid electrolytes, and complex hydride solid electrolytes. The sulfide solid electrolytes, the oxide solid electrolytes, the halide solid electrolytes, the polymer solid electrolytes, and the complex hydride solid electrolytes may be those described with respect to the positive electrode 220.

To facilitate the transfer of lithium ions and enhance the output characteristics of the battery, at least one of the positive electrode active material layer 13, the solid electrolyte layer 230, or the negative electrode active material layer 11 may include a nonaqueous electrolytic solution, a gel electrolyte, or an ionic liquid.

The nonaqueous electrolytic solution includes a nonaqueous solvent, and a lithium salt dissolved in the nonaqueous solvent. Examples of the nonaqueous solvents include cyclic carbonate ester solvents, chain carbonate ester solvents, cyclic ether solvents, chain ether solvents, cyclic ester solvents, chain ester solvents, and fluorinated solvents. Examples of the cyclic carbonate ester solvents include ethylene carbonate, propylene carbonate, and butylene carbonate. Examples of the chain carbonate ester solvents include dimethyl carbonate, ethyl methyl carbonate, and diethyl carbonate. Examples of the cyclic ether solvents include tetrahydrofuran, 1,4-dioxane, and 1,3-dioxolane. Examples of the chain ether solvents include 1,2-dimethoxyethane and 1,2-diethoxyethane. Examples of the cyclic ester solvents include γ-butyrolactone. Examples of the chain ester solvents include methyl acetate. Examples of the fluorinated solvents include fluoroethylene carbonate, methyl fluoropropionate, fluorobenzene, fluoroethyl methyl carbonate, and fluorodimethylene carbonate. The nonaqueous solvent that is used may be a single nonaqueous solvent selected from those described above, or may be a mixture of two or more nonaqueous solvents selected from those described above. The nonaqueous electrolytic solution may include at least one fluorinated solvent selected from the group consisting of fluoroethylene carbonate, methyl fluoropropionate, fluorobenzene, fluoroethyl methyl carbonate, and fluorodimethylene carbonate.

Examples of the lithium salts include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. The lithium salt that is used may be a single lithium salt selected from those described above, or may be a mixture of two or more lithium salts selected from those described above. For example, the concentration of the lithium salt is in the range of 0.5 to 2 mol/L.

The gel electrolyte that is used may be a polymer material impregnated with a nonaqueous electrolytic solution. The polymer material that is used may be at least one selected from the group consisting of polyethylene oxide, polyacrylonitrile, polyvinylidene fluoride, polymethyl methacrylate, and polymers having an ethylene oxide bond.

For example, the cation that constitutes the ionic liquid may be an aliphatic chain quaternary salt, such as a tetraalkyl ammonium or a tetraalkyl phosphonium; an aliphatic cyclic ammonium, such as a pyrrolidinium, a morpholinium, an imidazolinium, a tetrahydropyrimidinium, a piperazinium, or a piperidinium; or a nitrogen-containing heterocyclic aromatic cation, such as a pyridinium or an imidazolium. Alternatively, the anion constituting the ionic liquid may be, for example, PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, or C(SO₂CF₃)₃⁻. The ionic liquid may contain a lithium salt.

To enhance the adhesion between the particles, at least one of the positive electrode active material layer 13, the solid electrolyte layer 230, or the negative electrode active material layer 11 may include a binder. Binders are used to enhance binding properties of a material forming an electrode. Examples of the binders include polyvinylidene fluoride, polytetrafluoroethylene, polyethylene, polypropylene, aramid resins, polyamides, polyimides, polyamideimides, polyacrylonitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinylpyrrolidone, polyethers, polyether sulfones, hexafluoropolypropylene, styrene butadiene rubbers, and carboxymethylcellulose. Examples of the binders that may be used further include copolymers of two or more materials selected from tetrafluoroethylene, hexafluoroethylene, hexafluoropropylene, perfluoroalkyl vinyl ethers, vinylidene fluoride, chlorotrifluoroethylene, ethylene, propylene, pentafluoropropylene, fluoromethyl vinyl ether, acrylic acid, and hexadiene. Furthermore, a mixture of two or more materials selected from those described above may be used as the binder.

At least one of the positive electrode active material layer 13 or the negative electrode active material layer 11 may include a conductive auxiliary for the purpose of enhancing electron conductivity. Examples of the conductive auxiliaries that may be used include graphites, such as natural graphite and artificial graphite; carbon blacks, such as acetylene black and Ketjen black; conductive fibers, such as carbon fibers and metal fibers; fluorocarbons; metal powders, such as aluminum; conductive whiskers, such as zinc oxide and potassium titanate; conductive metal oxides, such as titanium oxide; and conductive polymer compounds, such as polyaniline, polypyrrole, and polythiophene. The use of a carbon conductive auxiliary allows for cost reduction.

The battery 100 in the present embodiment may be formed into various shapes, such as coin, cylindrical, prismatic, sheet, button, flat, and laminate.

### EXAMPLES

The present disclosure will be described in detail hereinbelow based on Examples and Comparative Examples.

### Preparation of Sulfide Solid Electrolyte A

In a glove box having an Ar atmosphere with a dew point of less than or equal to −60° C., Li₂S and P₂S₅ were weighed in a molar ratio of Li₂S:P₂S₅=75:25. These were crushed and mixed together in a mortar to give a mixture. Subsequently, the mixture was milled with a planetary ball mill (model P-7, manufactured by Fritsch Japan Co., Ltd.) at 510 rpm for 10 hours to form a vitreous solid electrolyte. The vitreous solid electrolyte was heat-treated in an inert atmosphere at 270° C. for 2 hours. Thus, a Li₂S—P₂S₅ powder was obtained as a glass ceramic sulfide solid electrolyte A.

### Example 1

### Preparation of Material Al for Negative Electrode Active Material Layer

In a glove box having an Ar atmosphere with a dew point of less than or equal to −60° C., Si and the sulfide solid electrolyte A were mixed together in a mass ratio of 7:3. A material Al was thus obtained. The Si used here was a powder.

### Preparation of Material B1 for Positive Electrode Active Material Layer

In a glove box having an Ar atmosphere with a dew point of less than or equal to −60° C., Li(Ni_{0.33}Co_{0.33}Mn_{0.33})O₂ and the sulfide solid electrolyte A were mixed together in a mass ratio of 7:3. A material B1 was thus obtained. The Li(Ni_{0.33}Co_{0.33}Mn_{0.33})O₂ used here was a powder.

### Preparation of Material C1 for Solid Electrolyte Layer Containing Fibrous Material

Polypropylene fibers (“KEMIBESTO FD-SS5” manufactured by MITSUI FINE CHEMICALS, Inc.) having an average diameter of 10 μm and an average length of 100 μm were used as a fibrous material. In a glove box having an Ar atmosphere with a dew point of less than or equal to −60° C., the fibrous material was mixed together with the sulfide solid electrolyte A so that the content ratio of the fibrous material to the sulfide solid electrolyte A would be 0.1 mass %. A material C1 was thus obtained.

### Fabrication of Secondary Battery

The steps described below were performed using the material A1, the material B1, the material C1, the sulfide solid electrolyte A, a copper foil (12 μm thick), and an aluminum foil (12 μm thick).

First, 2 mg of the material C1 and 10 mg of the material A1 were laminated in this order in an insulating cylindrical shell. The materials were compacted at a pressure of 360 MPa to form a laminated body of a negative electrode active material layer, and a solid electrolyte layer containing the fibrous material.

Next, a copper foil was laminated onto the layer of the material A1. The unit was pressed at 360 MPa to form a laminated body of the negative electrode current collector, the negative electrode active material layer, and the solid electrolyte layer containing the fibrous material.

Next, 2 mg of the sulfide solid electrolyte A and 10 mg of the material B1 were laminated in this order onto the layer of the material C1. These materials were compacted at a pressure of 360 MPa to form a laminated body of the negative electrode current collector, the negative electrode active material layer, the solid electrolyte layer containing the fibrous material, a solid electrolyte layer free from a fibrous material, and a positive electrode active material layer.

Next, an aluminum foil was laminated onto the layer of the material B 1. The unit was pressed at 360 MPa to form a laminating composed of the positive electrode, the solid electrolyte layer, and the negative electrode.

Next, stainless steel current collectors were arranged on and under the laminate boy, and current collector leads were attached to the current collectors.

Lastly, the insulating cylindrical shell was tightly closed with insulating ferrules to isolate the inside of the insulating cylindrical shell from the outer atmosphere. A battery of Example 1 was thus fabricated. In the battery of Example 1, the solid electrolyte layer and the negative electrode had the structure described with reference to FIG. 2. Specifically, the solid electrolyte layer in the battery of Example 1 had a structure in which the fibrous material was present only in the side of the solid electrolyte layer adjacent to the negative electrode.

### Example 2

### Preparation of Material C2 for Solid Electrolyte Layer Containing Fibrous Material

In a glove box having an Ar atmosphere with a dew point of less than or equal to −60° C., the fibrous material used in Example 1 was mixed together with the sulfide solid electrolyte A so that the content ratio of the fibrous material to the sulfide solid electrolyte A would be 0.2 mass %. A material C2 was thus obtained.

Fabrication of Secondary Battery

A battery of Example 2 was fabricated in the same manner as in Example 1, except that the material C1 was replaced by the material C2. In the battery of Example 2, the solid electrolyte layer and the negative electrode had the structure described with reference to FIG. 2.

### Example 3

### Preparation of Material C3 for Solid Electrolyte Layer Containing Fibrous Material

In a glove box having an Ar atmosphere with a dew point of less than or equal to −60° C., the fibrous material used in Example 1 was mixed together with the sulfide solid electrolyte A so that the content ratio of the fibrous material to the sulfide solid electrolyte A would be 1.0 mass %. A material C3 was thus obtained.

### Fabrication of Secondary Battery

A battery of Example 3 was fabricated in the same manner as in Example 1, except that the material C1 was replaced by the material C3. In the battery of Example 3, the solid electrolyte layer and the negative electrode had the structure described with reference to FIG. 2.

### Comparative Example 1

### Fabrication of Secondary Battery

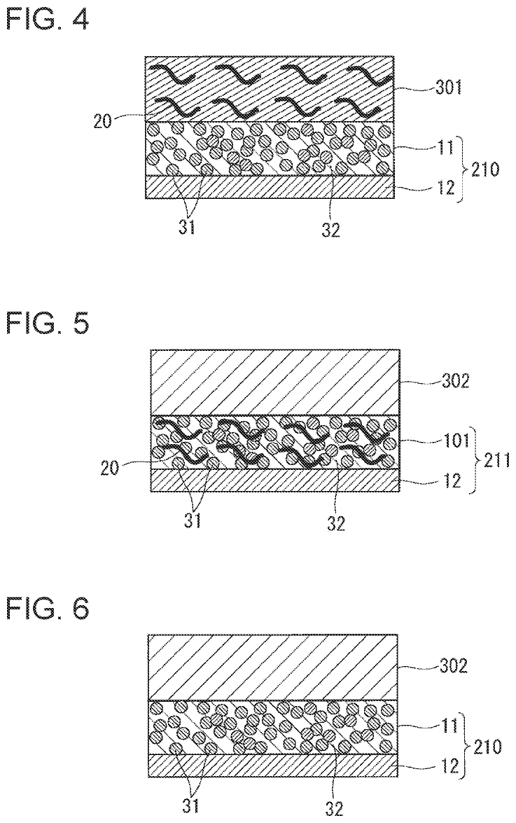

A battery of Comparative Example 1 was fabricated in the same manner as in Example 1, except that 2 mg of the material C1 and 10 mg of the material B1 were laminated in this order onto the layer of the material C1. In the battery of Comparative Example 1, the solid electrolyte layer 301 and the negative electrode 210 had a structure illustrated in FIG. 4. Specifically, the solid electrolyte layer 301 in the battery of Comparative Example 1 included the fibrous material in the whole of its structure.

### Comparative Example 2

### Preparation of Material a2 for Negative Electrode Active Material Layer

In a glove box having an Ar atmosphere with a dew point of less than or equal to −60° C., Si and the sulfide solid electrolyte A were mixed together in a mass ratio of 7:3. The fibrous material used in Example 1 was mixed together with the mixture so that the content ratio of the fibrous material to the mixture would be 0.1 mass %. A material a2 was thus obtained. The Si used here was a powder.

### Fabrication of Secondary Battery

A battery of Comparative Example 2 was fabricated in the same manner as in Example 1, except that the material A1 was replaced by the material a2, and that 2 mg of the sulfide solid electrolyte A and 10 mg of the material a2 were laminated in this order. In the battery of Comparative Example 2, the solid electrolyte layer 302 and the negative electrode 211 had a structure illustrated in FIG. 5. Specifically, the structure of the battery of Comparative Example 2 did not include any fibrous material in the solid electrolyte layer 302 and included the fibrous material in the negative electrode active material layer 101.

### Comparative Example 3

### Fabrication of Secondary Battery

A battery of Comparative Example 3 was fabricated in the same manner as in Example 1, except that 2 mg of the sulfide solid electrolyte A and 10 mg of the material A1 were laminated in this order. In the battery of Comparative Example 3, the solid electrolyte layer 302 and the negative electrode 210 had a structure illustrated in FIG. 6. Specifically, the structure of the battery of Comparative Example 3 did not include any fibrous material in the solid electrolyte layer 302 or the negative electrode active material layer 11.

The batteries of Examples 1 to 3 and Comparative Examples 1 to 3 were subjected to the following charge/discharge test. The theoretical capacities of the batteries of Examples and Comparative Examples were the same as one another.

### Test of Discharge Rate Characteristics

The battery was placed in a thermostat chamber at 25° C.

The battery was charged at a constant current of 770 μA corresponding to 0.05 C rate (20-hour rate) based on the theoretical capacity of the battery. The charging was terminated at a voltage of 4.2 V.

Next, the battery was discharged at a constant current of 770 μA corresponding to 0.05 C rate (20-hour rate). The discharging was terminated at a voltage of 2 V.

Furthermore, the battery was charged at a constant current of 770 μA corresponding to 0.05 C rate (20-hour rate) based on the theoretical capacity of the battery. The charging was terminated at a voltage of 4.2 V.

Next, the battery was discharged at a constant current of 4600 μA corresponding to 0.3 C rate (3.3-hour rate). The discharging was terminated at a voltage of 2 V.

The 0.3 C/0.05 C capacity ratio was calculated from the above two discharge rates. The results are described in Table 1. A higher 0.3 C/0.05 C capacity ratio indicates better discharge rate characteristics of the battery.

### Test of Charge-Discharge Efficiency

The battery was charged at a constant current of 770 μA corresponding to 0.05 C rate (20-hour rate) based on the theoretical capacity of the battery. The charging was terminated at a voltage of 4.2 V.

Next, the battery was discharged at a constant current of 770 μA corresponding to 0.05 C rate (20-hour rate). The discharging was terminated at a voltage of 2 V.

Twenty cycles of the above charging and discharging were performed, and the efficiency of discharge capacity/charge capacity after 20 cycles was calculated. The results are described in Table 1. A larger value of discharge capacity/charge capacity indicates higher charge-discharge efficiency of the battery.

TABLE 1

| | | | | Comp. | Comp. | Comp. |
|---|---|---|---|---|---|---|
| | Ex. 1 | Ex. 2 | Ex. 3 | Ex. 1 | Ex. 2 | Ex. 3 |
| Initial 0.3 C/0.05 C | 92.4 | 92.3 | 92.0 | 90.2 | 91.6 | 92.4 |
| capacity ratio (%) | | | | | | |
| Discharge capacity/ | 99.6 | 99.7 | 99.7 | 99.5 | 97.1 | 96.9 |
| charge capacity | | | | | | |
| efficiency (%) | | | | | | |
| after 20 cycles | | | | | | |

### Discussion

As described in Table 1, the batteries of Examples 1 to 3 attained a high 0.3 C/0.05 C capacity ratio and a high efficiency of discharge capacity/charge capacity after 20 cycles. The fibrous material present only in the second solid electrolyte layer on the negative electrode side probably eliminated or reduced the occurrence of cracks in the solid electrolyte layer without affecting the 0.3 C/0.05 C capacity ratio, and consequently a high charge-discharge efficiency was maintained.

In the battery of Comparative Example 1, the fibrous material present in the solid electrolyte layer eliminated or reduced the occurrence of cracks in the solid electrolyte layer, and a high charge-discharge efficiency was maintained. However, the 0.3 C/0.05 C capacity ratio was low probably because the whole of the solid electrolyte layer included the fibrous material that did not contribute to lithium-ion conduction, and the solid electrolyte layer had an increased value of resistance.

The battery of Comparative Example 2 was low in the 0.3 C/0.05 C capacity ratio and the efficiency of discharge capacity/charge capacity after 20 cycles. This is probably because the negative electrode active material layer had an increased value of resistance due to its containing the fibrous material, and, in addition, the absence of the fibrous material in the solid electrolyte layer resulted in cracks in the solid electrolyte layer.

The battery of Comparative Example 3 had a generally good 0.3 C/0.05 C capacity ratio. However, cracks occurred in the solid electrolyte layer, and consequently the efficiency of discharge capacity/charge capacity after 20 cycles was low.

### OTHER EMBODIMENTS

When the battery of the present disclosure has a higher expansion ratio of the positive electrode 220 than the expansion ratio of the negative electrode 210, the content ratio of the fibrous material 20 in the first solid electrolyte layer 15 may be larger than the content ratio of the fibrous material 20 in the second solid electrolyte layer 16. When the expansion ratio of the positive electrode 220 is higher than the expansion ratio of the negative electrode 210, the second solid electrolyte layer 16 may be free from any fibrous material.

For example, the battery of the present disclosure may be used as an all-solid-state lithium secondary battery.

What is claimed is:

1. A battery comprising:
a first electrode;
a second electrode; and
a solid electrolyte layer located between the first electrode and the second electrode and including a fibrous material,
wherein
the solid electrolyte layer includes a first solid electrolyte layer, and a second solid electrolyte layer located between the first solid electrolyte layer and the second electrode, and
the content ratio of the fibrous material in the second solid electrolyte layer is higher than the content ratio of the fibrous material in the first solid electrolyte layer.

2. The battery according to claim 1, wherein
the first solid electrolyte layer does not include the fibrous material.

3. The battery according to claim 1, wherein
the first electrode is a positive electrode, and
the second electrode is a negative electrode.

4. The battery according to claim 3, wherein
the negative electrode includes a negative electrode active material, and
the negative electrode active material includes at least one selected from the group consisting of silicon, tin, and titanium.

5. The battery according to claim 4, wherein
the negative electrode active material includes silicon.

6. The battery according to claim 1, wherein
the fibrous material includes a polyolefin.

7. The battery according to claim 6, wherein
the fibrous material includes polypropylene.

8. The battery according to claim 1, wherein
the content ratio of the fibrous material in the second solid electrolyte layer is greater than or equal to 0.05 mass % and less than or equal to 5 mass %.

9. The battery according to claim 8, wherein
the content ratio of the fibrous material in the second solid electrolyte layer is greater than or equal to 0.1 mass % and less than or equal to 1 mass %.

10. The battery according to claim 9, wherein
the content ratio of the fibrous material in the second solid electrolyte layer is greater than or equal to 0.1 mass % and less than or equal to 0.2 mass %.

11. The battery according to claim 1, wherein
the thickness of the second solid electrolyte layer is smaller than the thickness of the first solid electrolyte layer.

12. The battery according to claim 1, wherein
the first solid electrolyte layer includes a first solid electrolyte,
the second solid electrolyte layer includes a second solid electrolyte, and
the first solid electrolyte and the second solid electrolyte have lithium-ion conductivity.

13. A battery manufacturing method comprising laminating:
a first electrode;
a second electrode;
a first solid electrolyte layer between the first electrode and the second electrode; and
a second solid electrolyte layer between the first solid electrolyte layer and the second electrode,
wherein
the content ratio of a fibrous material in the second solid electrolyte layer is higher than the content ratio of a fibrous material in the first solid electrolyte layer.

14. The battery manufacturing method according to claim 13, wherein
the first solid electrolyte layer does not include the fibrous material.

15. The battery manufacturing method according to claim 13, wherein
the first electrode is a positive electrode, and
the second electrode is a negative electrode.
